(19) United States
(12) Patent Application Publication
(10) Pub. No.: US 2008/0067888 A1
(43) Pub. Date: Mar. 20, 2008

(54) BRUSH DEVICE AND FUEL PUMP

(75) Inventors: Seiji II, Obu-shi (JP); Akira HAMAJIMA, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/851,543

(22) Filed: Sep. 7, 2007

(30) Foreign Application Priority Data
Sep. 20, 2006 (JP) 2006-253858

(51) Int. Cl. H01R 39/40; F04B 17/03

(52) U.S. Cl. 310/245; 417/423.7

(57) ABSTRACT

The brush device is provided with a brush, a brush holder, and a biasing member. The brush holder has an insertion hole in which the brush is inserted. The biasing member biases the brush toward the sliding surface. The sliding surface is approximately perpendicular to the rotational axis of the commutator. The brush is inclined such that an end of the brush on a side of the commutator is positioned on a forward side of the other end of the brush with respect to a rotational direction of the commutator. A surface of the brush on the side of the commutator is approximately parallel with the sliding surface.

### CROSS-REFERENCE TO RELATED APPLICATION

This application claims priority to Japanese Patent Application No. 2006-253858 filed on Sep. 20, 2006, the contents of which are hereby incorporated by reference into the present application.

### BACKGROUND OF THE INVENTION

1. Field of the Invention

The present invention relates to a brush device and a fuel pump.

2. Description of the Related Art

A brush device has been used to supply a commutator of a motor with an electric current. The brush device generally includes a brush, a brush holder and a biasing member. The brush is in contact with a sliding surface of the commutator. The brush holder stores the brush. The biasing member biases the brush toward the sliding surface of the commutator. When the electric current is supplied to segments of the commutator from the brush, the electric current flows to coils of a rotor. The rotor is rotated by resulting magnetic fields. When the rotor rotates, the commutator also rotates. The brush slides on the sliding surface of the commutator. As a result, the electric current from the brush sequentially flows to the respective segments of the commutator, and the rotor thus maintains the rotation.

In this brush device, vibrations and noises of the brush while the motor is in operation pose problems. In order to solve the problems such as the vibrations and noises of the brush device, it is important to maintain a stable attitude of the brush during the operation of the motor. Various technologies have thus been developed. For example, an end surface, in contact with a coil spring (a biasing member), of a brush is formed inclined and the coil spring biases the brush toward an inner wall surface on one side of a brush holder. This configuration enables the brush to maintain contact with the inner wall surface of the brush holder. However, when this structure is employed, the coil spring is curved, and there thus poses a problem that the coil spring resonates or is self-excited.

In view of the foregoing problem, Japanese Laid-open Patent Application Publication No. 2004-173417 proposes a brush device for solving this problem. FIG. 4 is a longitudinal cross sectional view of the brush device disclosed. In FIG. 4, an arrow denotes a rotational direction of a commutator. This brush device includes a brush 110, a brush holder 120 and a coil spring 130. The brush 110 is in contact with an outer peripheral surface of the commutator, not shown. The brush holder 120 stores the brush 110. The coil spring 130 is installed in the brush holder 120. The coil spring 130 is interposed between an inclined surface 112 of the brush 110 and a bottom surface 140 of the brush holder 120 while the coil spring 130 is compressed. As a result, the bush 110 is biased toward the commutator. A guiding portion 150 is formed on the bottom surface 140 of the brush holder 120 in order to curve the coil spring 130. The biasing direction given to the coil spring 130 by the guiding portion 150 is opposite to the biasing direction given to the coil spring 130 by the inclined surface 112. As a result, they both cancel out each other, resulting in preventing the coil spring 130 from being curved.

### BRIEF SUMMARY OF THE INVENTION

For example, a fuel pump is used to supply an engine with fuel in a motor vehicle. Presently, the fuel pump is often integrated with a motor for a compact and highly efficient structure. In this case, such a structure is employed that a sliding surface of the commutator is an end surface orthogonal to the rotational axis of the motor instead of an outer peripheral surface thereof, and the brush is in contact with this end surface. If this structure is employed, the brush and the commutator are not adapted to each other, and thus have small contact areas at a beginning of an operational life in a conventional brush device. An electric current thus hardly flows smoothly from the brush to the commutator. As a result, there arises such a phenomenon that the rotational speed of the motor is low. According to an experiment carried out by the inventors, a period of 200 to 300 hours is required until the rotational speed of the motor reaches a predetermined value (i.e., design value). This causes a decrease in the fuel supplied by the fuel pump at the beginning of the operational life of the motor.

Accordingly, it is an object of the present teachings to provide a technology which can cause the rotational speed of a motor to quickly reach a predetermined value (i.e., design value) at the beginning of the operational life of a motor.

A detailed study of the inventors has revealed that the above problem is caused by an inclination of the brush when the motor is operating. FIG. 5 is a cross sectional view showing a conventional brush device. Dotted lines of a brush 210 in FIG. 5 show a state in which the commutator is not rotating. Solid lines of the brush 210 in FIG. 5 show a state in which the commutator is rotating in a direction indicated by an arrow. It should be noted that a coil spring biasing the brush 210 toward the commutator 180 is not shown in FIG. 5.

In a conventional brush device, the shape of the brush 210 is designed assuming that an attitude in which the brush 210 is orthogonal to an end surface 200 of the commutator 180 (i.e., design attitude) is maintained as the dotted lines in FIG. 5. In other words, the shape of the brush 210 is designed such that when the brush 210 is in the attitude orthogonal to the end surface 200 of the commutator 180, an end surface of the brush 210 is in surface contact with the end surface 200 of the commutator 180.

However, when the motor is operating, the brush 210 departs from the design attitude and becomes inclined as the solid lines shown in FIG. 5. Specifically, the brush 210 is inclined such that a top end of the brush 210 is displaced on the backward side (i.e., opposite to the forward side) in the rotational direction of the commutator 180, and a bottom end of the brush 210 is displaced on the forward side in the rotational direction of the commutator 180. As a result, the brush 210 is in line contact with the end surface 200 of the commutator 180. Therefore, electric current hardly flows from the brush 210 to the commutator 180, resulting in a rotational speed of the motor lower than a predetermined value (i.e., design value). The rotational speed of the motor thus does not reach the predetermined value (i.e., design value) until the brush wears to a state in which the end surface of the brush is in surface contact with the end surface of the commutator.

It should be noted that there are the following possible reasons for the inclination of the brush during the operation of the motor (during the rotation of the commutator). The brush 210 is stored in an insertion hole 230a of the brush holder 230 for moving forward and backward. When the brush 210 wears, the brush 210 moves toward the commutator 180 according to the amount of the wear. The brush 210 and the end surface 200 of the commutator 180 are thus always in contact with each other. There is clearance between the brush 210 and the insertion hole 230a. The brush 210 can thus smoothly move with respect to the insertion hole 230a. Moreover, the brush holder 230 is arranged so as to not come in contact with the end surface 200 of the commutator 180. There is clearance between a bottom end of the insertion hole 230a and the end surface 200 of the commutator 180. Furthermore, when the commutator 180 rotates, the commutator 180 applies a force to the brush 210 to incline the brush 210. It is conceived that the brush 210 inclines while the motor is in operation as a result. Particularly, the attitude of the brush in contact with the end surface (flat surface) of the commutator tends to be more instable than an attitude of a brush in contact with an outer peripheral surface (circumferential surface) of the commutator.

It is thus difficult to prevent the brush from inclining during the operation of the motor even if the above-mentioned known technology is employed. In other words, in order to prevent the brush from inclining according to the above-mentioned known technology, it is necessary to increase the biasing force of the coil spring, thereby pressing the brush 210 against the wall surface of the insertion hole 230a with a stronger force. However, if the biasing force of the coil spring is excessively large, a resistance against the rotation of the rotor increases, resulting in a decrease of the motor efficiency. There is thus a limit to the increase in the biasing force of the coil spring, and further more it is not possible to efficiently prevent the brush from inclining.

In one aspect of the present teachings, a brush device for supplying a commutator with an electric current is provided. The commutator includes a sliding surface approximately perpendicular to the rotational axis of the commutator. The brush device is provided with a brush, a brush holder, and a biasing member. The brush holder has an insertion hole in which the brush is inserted. The biasing member is configured to bias the brush toward the sliding surface of the commutator. The brush holder is configured to hold the brush such that an end of the brush on a side of the commutator is positioned on a forward side of the other end of the brush with respect to a rotational direction of the commutator. The brush is shaped such that a surface of the brush on the side of the commutator is approximately parallel with the sliding surface.

With this brush device, when the brush is inserted into the insertion hole and is biased by the biasing member, the brush is inclined with respect to the sliding surface of the commutator. In this state, the brush is shaped such that the end surface of the brush is in surface contact with the sliding surface of the commutator. As a result, it is possible to bring about the state in which the end surface of the brush is in surface contact with the sliding surface of the commutator at the beginning of the operational life of a motor. The brush can supply large electric currents to the commutator. As a result, it is possible to cause the rotational speed of the motor to quickly reach a predetermined value (i.e., design value).

Other objects, features and advantages of the present teachings will be readily understood after reading the following detailed description together with the accompanying drawings and claims. Of course, the additional features and aspects disclosed herein may be utilized singularly or, in combination with the above-described aspect and features.

### BRIEF DESCRIPTION OF THE DRAWINGS

FIG. 1 is a cross sectional view of a fuel pump according to a first representative embodiment.

FIG. 2 is an enlarged cross sectional view of a brush device according to the first representative embodiment.

FIG. 3 is an enlarged cross sectional view of a brush device according to a second representative embodiment.

FIG. 4 is a cross sectional view of a conventional brush device.

FIG. 5 describes a problem of a case in which the conventional brush device is applied to a commutator including a sliding surface approximately orthogonal to the rotational axis of a motor.

### DETAILED DESCRIPTION OF THE INVENTION

Major characteristics of embodiments described below are listed.

(Feature 1) A shape of a brush is determined based upon clearance between a brush and an insertion hole of a brush holder, and/or a clearance between a sliding surface of a commutator and the brush holder.

(Feature 2) A shape of the brush is determined in consideration of a manufacturing tolerance of the respective clearances above.

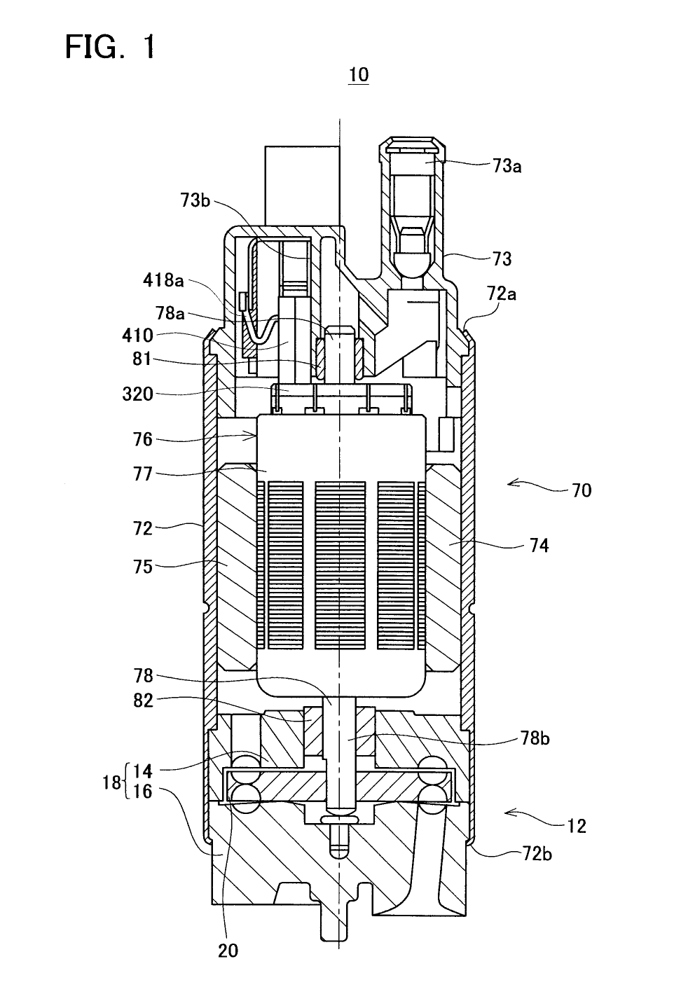

(First representative embodiment) First, a description will be given of a first representative embodiment of a fuel pump employing a brush device according to the present teachings. FIG. 1 is a longitudinal cross sectional view of a fuel pump 10. As shown in FIG. 1, the fuel pump 10 includes a motor unit 70 and a pump unit 12. A compact structure is realized in the fuel pump 10 by integrating the motor unit 70 and the pump unit 12 with each other.

The motor unit 70 is provided with a housing 72, magnets 74 and 75, and a rotor 76. The housing 72 is formed as an approximately cylindrical shape. A motor cover 73 is fixed to a top end 72a of the housing 72. A discharging port 73a is formed on a top surface of the motor cover 73. An insertion hole 73b is formed on a bottom surface of the motor cover 73. A brush 410 is inserted into the insertion hole 73b. The motor cover 73 thus serves as a brush holder according to the present embodiment. The magnets 74 and 75 are fixed to an inner wall of the housing 72. The rotor 76 includes a shaft 78, a main unit 77 fixed to the shaft 78, and a commutator 320 which is fixed to the shaft 78. The main unit 77 includes a laminated iron core and coils. The coils of the main unit 77 are connected to the commutator 320. A top end 78a of the shaft 78 is rotatably installed on the motor cover 73 via a bearing 81. A bottom end 78b of the shaft 78 is rotatably installed on the pump unit 12 via a bearing 82.

The pump unit 12 includes a casing 18 and an impeller 20. The casing 18 is fixed to a bottom end 72b of the housing 72. The casing 18 includes a pump cover 14 and a pump body 16. The impeller 20 is rotatably disposed within the casing 18. A through hole passing in the thickness direction is formed at the center of the impeller 20, and the shaft 78 is engaged through this through hole. When an electric current is supplied to the coils of the rotor 76 via the brush 410 and commutator 320, the rotor 76 rotates, and the impeller 20 also rotates accordingly.

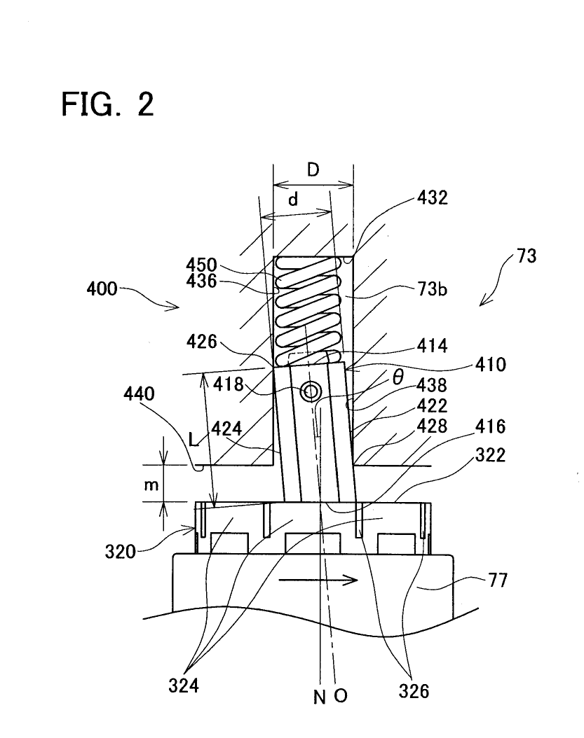

The commutator 320 is split into multiple segments 324 by slits 326 as shown in FIG. 2. The commutator 320 is provided with eight segments 324 according to the present embodiment. Each segment 324 is electrically connected to ends of the coils (not shown) of the main unit 77. A top end surface of each segment 324 is coplanar. Hereinafter, a plane formed by the top end surfaces of the segments 324 will be referred to as top end surface 322 of the commutator 320. As FIG. 2 clearly shows, the top end surface 322 of the commutator 320 is orthogonal to the axis of the shaft 78. It should be noted that when the motor unit 70 becomes active, the commutator 320 rotates in a direction indicated by an arrow shown in FIG. 2. The direction indicated by the arrow will be referred to as rotational direction of the commutator 320 (or simply rotational direction), and the direction opposite to the direction indicated by the arrow will be referred to as reverse rotational direction of the commutator 320 (or simply reverse rotational direction) hereinafter.

A brush device 400 comprises a brush 410, a coil spring 450 and the motor cover 73 in which the insertion hole 73b is formed. The coil spring 450 biases the brush 410 toward the top end surface 322 of the commutator 320. The motor cover 73 holds the brush 410. The brush 410 is an electrode member, a cross section of which is approximately rectangular. A top end surface 414 of the brush 410 is formed so as to be orthogonal to a center-line O of the brush 410. A bottom end surface 416 of the brush 410 is formed so as to be inclined with respect to the center-line O of the brush 410. This means that center-line O of the brush 410 and the bottom end surface 416 of the brush 410 include an angle different from 90-degree. The insertion hole 73b has an inner wall 436, 438 and a bottom surface 432. A shape of the cross section of the insertion hole 73b is approximately the same as that of the brush 410. The insertion hole 73b is formed approximately in parallel with the axis of the shaft 78. The cross section of the insertion hole 73b is formed so as to be slightly larger than the cross section of the brush 410. As a result, the brush 410 can smoothly move in the vertical direction in the insertion hole 73b.

The coil spring 450 is disposed between the bottom surface 432 of the insertion hole 73b and the top end surface 414 of the brush 410 while the coil spring 450 is compressed. As a result, the biasing force of the coil spring 450 always maintains the bottom end surface 416 of the brush 410 in contact with the top end surface 322 of the commutator 320. In other words, when the brush 410 has been worn, the brush 410 moves downward, (on the side of the commutator 320) by the amount of the wear, by the biasing force of the coil spring 450, thereby maintaining the state in which the bottom surface 416 of the brush 410 and the top end surface 322 of the commutator 320 are in contact with each other. Moreover, a contact 418 is formed on the brush 410. A slit (not shown) is formed on the motor cover 73. The slit extends vertically at a position corresponding to the contact 418. A pigtail 418a (shown in FIG. 1) is electrically connected to the contact 418 through the slit. When the motor is operating, electric currents from an external power supply flow to the brush 410 through the pigtail 418a and the contact 418. The electric current which has flown to the brush 410 flows, through the bottom end surface 416 of the brush 410 and the top end surface 322 of the commutator 320, to the coils of the rotor 76.

A more detailed description will be given of the brush 410. The brush 410 is stored in the insertion hole 73b so as to be inclined with respect to the top end surface 322 of the commutator 320 as shown in FIG. 2. Specifically, the brush 410 is inclined such that the bottom end surface 416 thereof is displaced on the rotational direction of the commutator 320 more than the top end surface 414 thereof. As a result, the brush 410 is in contact with the inner wall surface 438 on the forward side in the rotational direction, the inner wall surface 436 on the backward side in the rotational direction of the insertion hole 73b, and the top end surface 322 of the commutator 320, and this attitude is maintained. Specifically, a corner portion 426 between a left side surface 424 and the top end surface 414 of the brush 410 is in contact with the inner wall surface 436 of the insertion hole 73b, a portion 428 close to a bottom end of a right side wall 422 of the brush 410 is in contact with the inner wall surface 438 of the insertion hole 73b, and the bottom end surface 416 of the brush 410 is in contact with the top end surface 322 of the commutator 320. Therefore, the shape of the brush 410 is designed such that the bottom end surface 416 of the brush 410 is parallel with (in surface contact with) the top surface 322 of the commutator 320, the brush 410 is in contact with both the inner wall surfaces 436 and 438 of the insertion hole 73b, and this attitude is maintained when the brush 410 is installed in the insertion hole 73b of the motor cover 73. Moreover, the shape of the brush 410 may be designed such that the brush 410 is in contact with both the inner wall surfaces 436 and 438 of the insertion hole 73b when the brush 410 is installed in the insertion hole 73b, and the commutator 320 is rotating.

In the brush device 400 of the first representative embodiment, the coil spring 450 biases the brush 410 downward, and the top end surface 322 of the commutator 320 thus supports the bottom end surface 416 of the brush 410. As a result, the motor cover 73 can support the left side surface 424 and the right side surface 422 of the brush 410. As a result, it is possible to maintain the stable attitude of the brush 410 while the commutator 320 is rotating. It is thus possible to restrain noises and vibrations of the brush device 400 during the operation of the motor unit 70.

Moreover, at the beginning of the operational life of the fuel pump 10, the bottom end surface 416 of the brush 410 is in surface contact with the top end surface 322 of the commutator 320. Therefore, it is possible to stably supply each segment 324 of the commutator 320 with the electric current from the brush 410. In other words, in the brush device 400, in consideration of the clearance between the brush 410 and the insertion hole 73b of the motor cover 73 and the clearance between the bottom end surface 440 of the motor cover 73 and the top end surface 322 of the commutator 320, the bottom end surface 416 of the brush 410 is formed inclined with respect to the center-line O such that the bottom end surface 416 of the brush 410 is parallel with the top end surface 322 of the commutator 320 when the brush 410 is stored in the inclined state in the insertion hole 73b. As a result, the bottom end surface 416 of the brush 410 can make surface contact with the top end surface 322 of the commutator 320 even at the beginning of the operational life of the fuel pump 10.

Further, the brush 410 is in contact with inner wall surfaces of the insertion hole 73b at two points. It is possible to prevent the brush 410 from departing from a predetermined inclined attitude due to vibrations and backlashes during the operation of the motor. Moreover, when the biasing force of the coil spring 450 is transmitted to the bottom end surface 416 of the brush 410 and the top end surface 322 of the commutator 320, a pressing force is larger on the backward side of the rotational direction than on the forward side of the rotational direction on these surfaces in contact. As a result, even if the brush 410 wears due to the operation for a long period, it is possible to further incline the brush 410 toward the forward side in the rotational direction according to the amount of the wear of the brush 410. As a result, even if the brush 410 wears, it is possible to bring the bottom end surface 416 of the brush 410 in surface contact with the top end surface 322 of the commutator 320.

As the above description clearly shows, in the first representative embodiment, how much the bottom surface 416 of the brush 410 is inclined with respect to the center-line O is determined by how much the brush 410 is inclined with respect to the top end surface 322 of the commutator 320 (inclination angle θ). In FIG. 2, when the width of the insertion hole 73b is denoted by D; the width of the brush 410, d; the shorter side (left edge in the drawing) of the brush 410, L; and the distance between the bottom end surface 440 of the motor cover 73 and the top end surface 322 of the commutator 320, m, the inclination angle θ can be represented as a function f(D, d, L, m). In other words, the inclination angle θ can be obtained when the parameters D, d, L, and m are determined. A geometric calculation can be solved by well-known trigonometric functions, and hence a description thereof is omitted. In general, if L is constant, the larger (D-d) or m becomes, the larger the inclination angle θ becomes. Once the inclination angle θ is determined, the planar shape of the brush 410 can be determined.

As steps for determining the planar shape of the brush 410, for example, first, the parameters D, d, L, and m are determined, and at least either the clearance (D-d) or the clearance m is obtained. Then, the inclination angle θ (e.g., an angle between the center line O and a line N (line parallel with the rotational axis)) of the brush 410 is calculated based on this clearance. A shape of the bottom end surface 416 of the brush 410 is then determined based on the inclination angle θ. Consequently, the planer shape of the brush 410 can be determined.

It should be noted that the bottom end surface 416 of the brush 410 is in surface contact with the top end surface 322 of the commutator 320 at the beginning of the operational life of the fuel pump 10 by design. However, in practice, due to manufacturing errors of the brush 410 and the motor cover 73, the bottom end surface 416 of the brush 410 may not be in surface contact with the top end surface 322 of the commutator 320 at the beginning of the operational life of the fuel pump 10. Since the brush device 400 is configured as described above, an amount of the wear can be small until the bottom end surface 416 of the brush 410 comes in surface contact with the top end surface 322 of the commutator 320. Therefore, the bottom end surface 416 of the brush 410 comes in surface contact with the top end surface 322 of the commutator 320 in a short period after the beginning of the operation life of the fuel pump 10. According to experiments carried out by the inventors, the period until the electric currents supplied from the brush 410 to the commutator 320 reach predetermined values (i.e., design values) can be reduced from that of conventional devices ranging from 200 to 300 hours to approximately 10 hours, and it is thus possible to cause a fuel supply to quickly reach a predetermined value (i.e., design value).

Moreover, according to the first representative embodiment, the attitude of the brush 410 is determined by the contacts of the brush 410 with the inner wall surfaces 436 and 438 of the insertion hole 73 and the top end surface 322 of the commutator 320. The biasing force of the coil spring 450 (more specifically, a component force thereof orthogonal to the top end surface 322 of the commutator 320) does not contribute to the stability of the attitude of the brush 410. The biasing force of the coil spring 450 can thus have a magnitude as large as that can maintain the contact between the bottom end surface 416 of the brush 410 and the top end surface 322 of the commutator 320. As a result, the biasing force of the coil spring 450 will not be too large, and the resistance against the rotation of the rotor 76 will thus not be too large. The biasing force (more specifically, the component force in the direction orthogonal to the top end surface 322 of the commutator 320) of the coil spring 450 can be determined in consideration solely of the pump efficiency. As a result, it is possible not to decrease the efficiency of the fuel pump.

It should be noted that a corner between the bottom end surface 416 and the right side surface 422 of the brush 410, or a corner between the bottom end surface 416 and the left side surface 424 may be chamfered in the brush device 400. In this case, even if the bottom end surface 416 of the brush 410 and the top end surface 322 of the commutator 320 are not parallel with each other due to manufacturing errors, these errors can be absorbed. In other words, even if the brush 410 is in line contact with the top end surface 322 of the commutator 320 due to the manufacturing errors of the brush 410, it is possible to remarkably reduce the period until the brush 410 wears thereby forming a stable sliding surface.

Moreover, according to the first representative embodiment, since the top end surface 414 of the brush 410 is configured so as to be orthogonal to the center-line O, the force curving the coil spring 450 is generated in the coil spring 450. Therefore, a guiding portion may be formed on the bottom surface 432 of the insertion hole 73b in order to prevent the coil spring 450 from being curved as described in Japanese Laid-open Patent Application Publication No. 2004-173417.

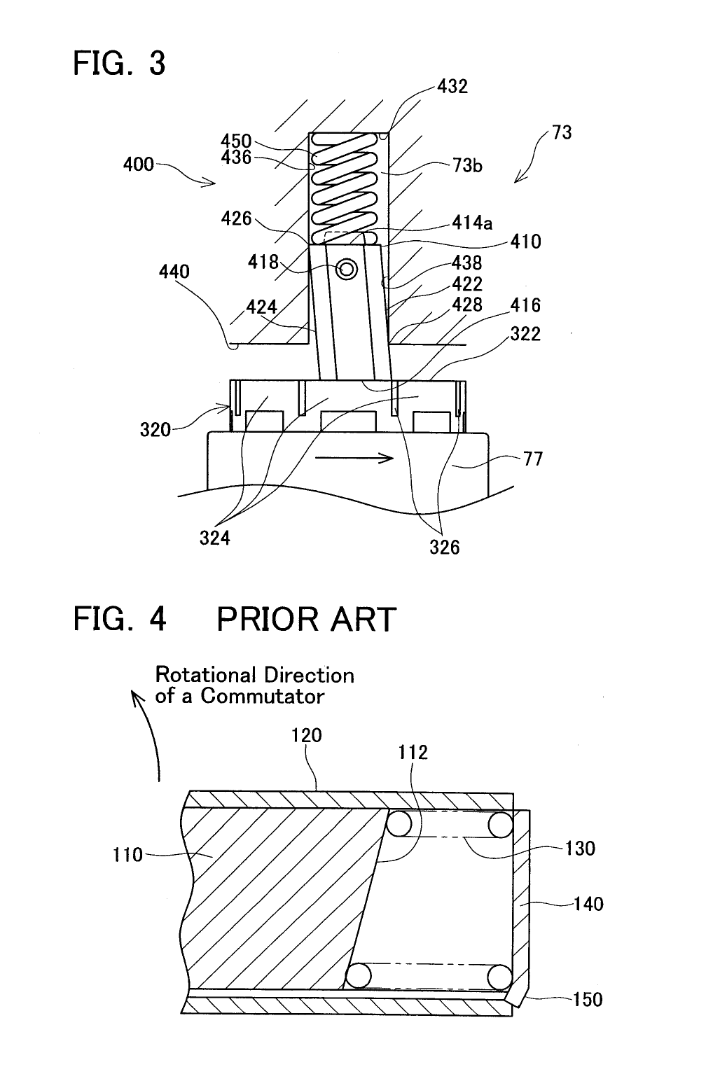

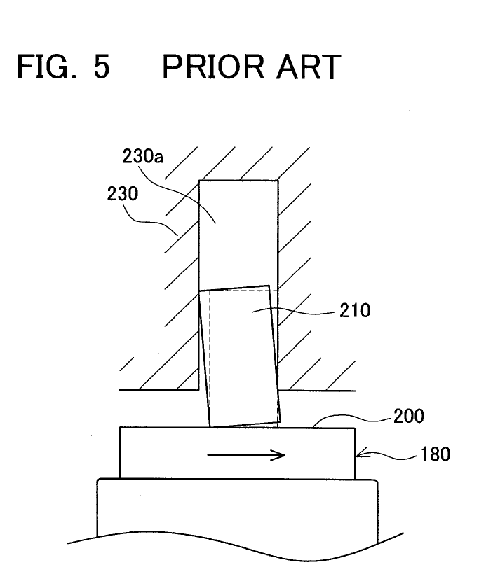

(Second representative embodiment) A description will be given of a brush device according to a second representative embodiment with reference to FIG. 3. Parts and elements corresponding to those of the first representative embodiment are designated by identical reference numerals, and description thereof is omitted.

The top end surface 414 of the brush 410 is approximately orthogonal to the center-line O of the brush 410 according to the first representative embodiment. A top end surface 414a of the brush 410 is inclined with respect to the center-line O of the brush 410 in the brush device 400 according to the second representative embodiment as shown in FIG. 3. This means that center-line O of the brush 410 and the top end surface 414a of the brush 410 include an angle different from 90-degree. Specifically, the top end surface 414a of the brush 410 is inclined so as to be parallel with the bottom end surface 416 of the brush 410. As a result, the top end surface 414a of the brush 410 is parallel with the top end surface 322 of the commutator 320 when the brush 410 is installed in the insertion hole 73b. Moreover, the biasing force of the coil spring 450 also acts in the direction to rotate the brush 410 counterclockwise.

The biasing force of the coil spring 450 generates a moment rotating the brush 410 counterclockwise in the brush device 400 of the second representative embodiment. Therefore, the corner 426 between the left side surface 424 and the top end surface 414a of the brush 410 is pressed against the inner wall surface 436 of the insertion hole 73b, and the portion 428 close to the bottom end of the right side wall 422 of the brush 410 is pressed against the inner wall surface 438 of the insertion hole 73b. Therefore, it is possible to stabilize the attitude of the brush 410 more. Moreover, since the direction of the biasing force of the coil spring 450 is orthogonal to the top end surface 322 of the commutator 320, the bottom end surface 416 of the brush 410 is approximately evenly pressed against the top end surface 322 of the commutator 320, resulting in even wear of the entire brush 410. Therefore, it is possible to stabilize the attitude of the brushes 410 for a long period.

Moreover, in the second representative embodiment, generating a force which curves the coil spring 450 is avoided. Therefore, it is not necessary to form a guiding portion on the bottom surface 432 of the insertion hole 73b in order to prevent the coil spring 450 from being curved.

The top end surface 414a of the brush 410 is not necessarily parallel with the bottom end surface 416 of the brush 410. The top end surface 414a may be inclined at an angle which causes the biasing force of the coil spring 450 to generate a counterclockwise rotation of the brush 410. In other words, the top end surface 414a of the brush 410 may be inclined such that the point of action of the biasing force of the coil spring 450 is displaced on the backward side in the rotational direction of the center of gravity of the brush 410. As a result, it is possible to press the brush 410 against the inner wall surfaces 436 and 438 of the insertion hole 73b, thereby stabilizing the attitude of the brush 410.

Finally, although the preferred representative embodiments have been described in detail, the present embodiments are for illustrative purpose only and are not restrictive. It is to be understood that various changes and modifications may be made without departing from the spirit or scope of the appended claims. In addition, the additional features and aspects disclosed herein may also be utilized singularly or in combination with the above aspects and features.

What is claimed is:

1. A brush device for supplying a commutator with an electric current, the brush device comprising:
a brush;
a brush holder having an insertion hole in which the brush is inserted; and
a biasing member configured to bias the brush toward a sliding surface of the commutator, the sliding surface being approximately perpendicular to a rotational axis of the commutator,
wherein the brush holder is configured to hold the brush such that an end of the brush on a side of the commutator is positioned on a forward side of the other end of the brush with respect to a rotational direction of the commutator, and
the brush is shaped such that a surface of the brush on the side of the commutator is approximately parallel with the sliding surface.

2. A brush device as in claim 1, wherein the surface of the brush on the side of the commutator is inclined with respect to a center line of the brush.

3. A brush device as in claim 2, wherein the brush holder is further configured to hold the brush such that at least when the commutator is rotating, (1) the other end of the brush makes contact with an inner surface of the insertion hole, and (2) a side surface of the brush on the forward side in the rotational direction makes contact with an end of the insertion hole on a side of the commutator.

4. A brush device as in claim 3, wherein the brush holder is further configured to hold the brush such that even when the commutator is not rotating, (1) the other end of the brush makes contact with an inner surface of the insertion hole, and (2) a side surface of the brush on the forward side in the rotational direction makes contact with an end of the insertion hole on a side of the commutator.

5. A brush device as in claim 4, wherein the insertion hole is arranged so as to be approximately parallel with the rotational axis of the commutator.

6. A brush device as in claim 5, wherein a shape of the cross section of the insertion hole is approximately the same as that of the brush, and the cross section of the insertion hole is slightly larger than the cross section of the brush.

7. A brush device as in claim 6, wherein a direction of a biasing force exerted by the biasing member is arranged so as to be approximately perpendicular to the sliding surface.

8. A brush device as in claim 2, wherein a surface of the brush on the side of the biasing member is substantially perpendicular to the center line of the brush.

9. A brush device as in claim 2, wherein a surface of the brush on the side of the biasing member is inclined with respect to the center line of the brush such that the point of action of the biasing force of the biasing member is displaced on the backward side in the rotational direction of the center of gravity of the brush.

10. A brush device as in claim 9, the surface of the brush on the side of the biasing member is inclined so as to be substantially parallel with the surface of the brush on the side of the commutator.

11. A fuel pump comprising:
a pump unit; and
a motor unit configured to drive the pump unit, the motor unit comprising a commutator, and
a brush device as in claim 1, the brush device being configured to supply the commutator with an electric current.
